(19) United States
(12) Patent Application Publication
(10) Pub. No.: US 2007/0271583 A1
(43) Pub. Date: Nov. 22, 2007

(54) Multiple channel vehicle entertainment device

(76) Inventor: Jack Chen, Oak Brook, IL (US)

Correspondence Address: ROBERT L. MARSH, 54 DANADA DRIVE, P.O. BOX 4468, WHEATON, IL, 60187-4468, US

(21) Appl. No.: 11/436,018

(22) Filed: May 17, 2006

(51) Int. Cl. H04N 7/18

(52) U.S. Cl. 725/75; 725/77

(57) ABSTRACT

A vehicle entertainment center includes a plurality of bays for receiving electronically reproducible entertainment. The bays include memory card bays. The entertainment center has a plurality of channel readers with each channel reader capable of reading a separate entertainment channel accessible through one of the plurality of bays. There is also a plurality of receivers for receiving wireless transmitted entertainment from each of the channel readers. Each of the receivers is capable of selecting to receive the entertainment channel being projected by one of the channel readers and playing the selected channel to a passenger in a vehicle such that each passenger can hear and view an entertainment channel that is different from that viewed and heard by any other passenger.

### BACKGROUND OF THE INVENTION

The radio was the first form of electronic entertainment provided in a motor vehicle. Since then, vehicles have been equipped with tape players, disc players, video disc players, and the like. Currently, electronically reproduced audio entertainment can be provided through earphones so that the audio entertainment enjoyed by one passenger need not interfere with conversation or other entertainment enjoyed by others in the vehicle. Currently, however, entertainment devices such as a disc player or the like, are capable of providing only one type of electronic entertainment at a time. If the entertainment is in the form of a motion picture recorded on the disc or the like, the passengers in the vehicle, other than the driver, can view the video and listen to the sound track associated therewith, but the driver cannot simultaneously listen to another source of entertainment such as electromagnetically transmitted AM or FM radio. If the driver wishes to enjoy an electromagnetically reproduced entertainment, such as a conventional radio station while the system provided in the vehicle is providing video entertainment to the passengers, he must bring with him his own portable receiver.

Although vehicles typically have a single device for providing electronically reproduced entertainment, it is becoming common for individuals to seek out and enjoy entertainment suited to their own taste, to the exclusion of group entertainment. It is also anticipated that driveless memory cards will soon be publicly available where the driveless card is capable of maintaining a plurality of videos, or other forms of reproducible entertainment all in the same card. It would be desirable, therefore, to provide a multiple channel entertainment device for a vehicle in which various individuals in the vehicle could enjoy the entertainment of their choice.

### SUMMARY OF THE INVENTION

It is the purpose of the present invention to take advantage of the expected availability of the driveless DVD memory card. Such memory cards are expected to carry 40 gigabytes of memory such that the card could retain as many as ten full length motion pictures. Whereas currently existing technology, such as an audio or video tape or disc retains the information on the surface of a media, such as the length of the tape or the concentric rings of a disc, a driveless DVD memory card will retain the information in a binary code such that all bands or channels of memory are immediately electronically accessible by a player. While existing tape and disc players are limited to providing entertainment through but a single band or channel at a time, a player utilizing a driveless DVD memory card can potentially access a plurality of channels available on the memory card and play several, or even all, of the channels on the memory card simultaneously. For the purpose of this discussion, the term “channel” shall refer to a sequence of electronically readable messages which, when directed through a suitable electronic player, will reproduce a given pre-recorded audio or video performance. Also, for the purposes of this discussion, a driveless DVD memory card of the type previously described that is capable of simultaneously retaining a plurality of performance channels, will be hereinafter referred to as a “memory card.”

The present invention is therefore embodied in an entertainment selector suitable for use in a vehicle that includes a plurality of channel readers. Each of the channel readers may independently read any one of the channels of a single memory card. Preferably, the device may retain a plurality of such memory cards such that each of the channel readers may read a channel from any one of the memory cards receivable by the entertainment center. Each of the plurality of channel readers has associated therewith a wireless transmitter for transmitting the channel being read through one of the reception bays to one of a plurality of personal audio/video players positioned within the vehicle. Each audio/video player includes an electromagnetic receiver, a pair of earphones and a personal video screen positioned to be viewed by a single passenger. Accordingly, each of the audio/video players is capable of receiving and playing a different audio/video channel to a different passenger in the vehicle.

It is an aspect of the invention that each of the channel readers is capable of reading a channel of information from either one or more memory cards, or from an AM or FM receiver, from a DVD player, or from a jack allowing input from a portable device such as a portable video camera.

### BRIEF DESCRIPTION OF THE DRAWINGS

A better understanding of the present invention will be had after a reading of the following detailed description taken in conjunction with the drawings wherein:

FIG. 1 is a schematic view of a vehicle having an entertainment center with a plurality of bays in accordance with the present invention, and having a plurality of audio/video players positioned through the vehicle with each player suitable for entertaining a single passenger;

FIG. 2 is a front elevational view of the entertainment center shown in FIG. 1;.

FIG. 3 is a schematic diagram of the entertainment center shown in FIG. 2; and

FIG. 4 is a schematic diagram of a channel receiver in accordance with the invention.

### DETAILED DESCRIPTION OF A PREFERRED EMBODIMENT

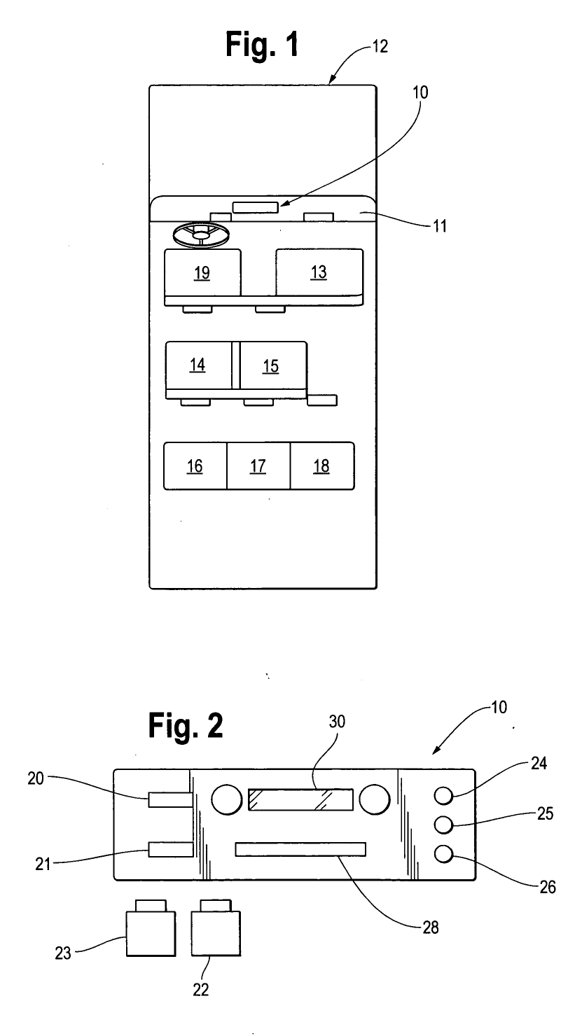

The present invention is useable in any currently existing form of transportation, such a motor vehicle, airplane, boat, or the like where the control of the entertainment center is positioned at a single location. Referring to FIGS. 1 and 2, for the purpose of this discussion an entertainment center 10 in accordance with the present invention is mounted in the dashboard 11 of a vehicle 12. The cabin of the vehicle 12 includes a plurality of passenger seats 13, 14, 15, 16, 17, 18 and a driver's seat 19. The entertainment center 10 is provided with a plurality of bays 20, 21 each of which is suitable for receiving a memory card 22, 23. It is currently expected that the bays 21, 22 will have a USB 2.0 type connector for receiving the currently envisioned driveless DVD memory card, however, it should be appreciated that the invention envisions any form of connector for receiving a memory card retaining one or more entertainment channels. The entertainment center 10 further includes a plurality of jacks 24, 25, 26, each of which is capable of receiving an electronically reproducible input from another source, such as a portable DVD player, a video camera, or the like. The entertainment center 10 may also have a conventional bay 28 for receiving currently available disc type DVDs and may also include a currently available electromagnetic receiver 30 such as an AM or FM radio.

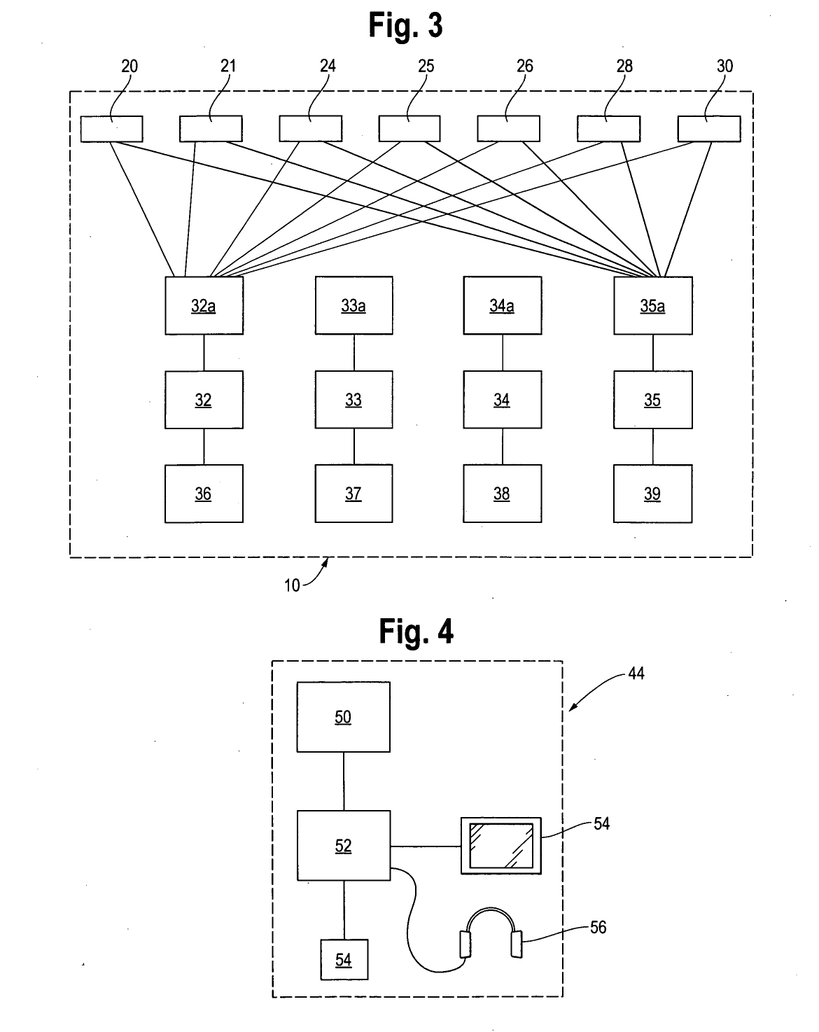

Referring to FIGS. 2 and 3, the electronics of the entertainment center 10 include a plurality of channel readers 32, 33, 34, 35. Although FIG. 3 depicts only channel readers 32 and 35 connected to all the available bays, all the channel readers are in fact connected to all the bays 21, 22, 24, 25, 26, 28, 30. Each channel reader has an associated selector 32A, 33A, 34A, 35A that is capable of selecting and reading any one of the channels from either of the bays 20, 21 or from one of the jacks 24, 25, 26, or from the DVD bay 28 or the receiver 30. Each channel reader 32-35 has associated therewith a separate wireless channel transmitter 36, 37, 38, 39 such that at any one time, a plurality of entertainment channels, as read by the various channel readers, may be simultaneously transmitted by the channel transmitters 36-39.

Referring further to FIGS. 1 and 4, also positioned around the vehicle are a plurality of receivers 42, 43, 44, 45, 46, 47, 48, one for each passenger in the seats 13-19. The receivers 44-48, intended to be used by passengers in the rear seats of the vehicle, are all identical and receiver 44 is considered representative of all these units. Each of the rear passenger receivers includes an electromagnetic receiver with a selector switch 50 for selecting the transmission from one of the channel transmitters 36-39 and a channel player 52. The channel player 52 includes individual controls 54 for controlling audio volume, video contrast, and the like, and an on/off switch. Each player 52 also includes a video screen 54 for projecting the video read and transmitted by one of the channel readers 32-35 and the channel transmitter 36-39, and a pair of ear phones 56. The players 42, 43 that provide entertainment to the driver and the front seat passenger are similar to players 44-48, but they do not include video screens so as not to distract the driver while he is driving. Accordingly, at any one time, each one of the various passengers of a vehicle may choose to be entertained by a separate entertainment channel as read by one of the channel readers 32-35. The channel readers 32-35 may likewise be directed to read any one of the channels available on the memory cards 22, 23 inserted into the base 20, 21, or being received by the entertainment center 10 through one of the jacks 24-26, or the bay 28, or the electromagnetic receiver 30. Accordingly, the driver and every passenger in the vehicle may choose to be entertained by an entertainment channel that is different from that being viewed and heard by any other passenger in the vehicle.

While the present invention has been described with respect to a single embodiment, it will be appreciated that many modifications and variations may be made without departing from the true spirit and scope of the invention. It is therefore the intent of the appended claims to cover all such modifications and variations that fall within the true spirit and scope of the invention.

What is claimed:

1. A multiple channel vehicle entertainment device comprising a plurality of audio/video input bays, a plurality of channel readers for simultaneously receiving a plurality of audio/video inputs;
wireless means for separately transmitting each of said video/audio inputs to a remote receiver;
a plurality of audio/video players;
each of said audio/video players having a wireless receiver wherein each of said audio/video players will receiver and play a different one of said separately transmitted video/audio inputs.

2. The entertainment device of claim 1 wherein said plurality of audio/video input bays includes a receptor for receiving a driveless DVD memory card.

3. The entertainment device of claim 2 wherein said receptor for receiving a driveless DVD memory card is a USB 20.

4. The entertainment device of claim 2 wherein said entertainment bay can differentiate and simultaneously transmit a plurality of audio/video recordings from said driveless DVD memory card.

5. The entertainment device of claim 1 wherein said plurality of audio/video input includes a plurality of receptors for receiving DVD memory cards.

6. The entertainment device of claim 1 wherein said plurality of audio/video input bays includes an AM/FM receiver.

7. The entertainment device of claim 1 wherein said plurality of audio/video input bays includes a DVD player.
